(19) United States
(12) Patent Application Publication
(10) Pub. No.: US 2016/0057004 A1
(43) Pub. Date: Feb. 25, 2016

(54) SYSTEMS AND METHODS FOR MACHINE-TO-MACHINE AD-HOC COMMUNICATION

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 14/464,876

(22) Filed: Aug. 21, 2014

(51) Int. Cl. H04L 12/24; H04W 84/22; H04L 12/721; H04W 76/02; H04L 29/08; H04L 12/723; H04W 4/00

(52) U.S. Cl. CPC H04L 41/0806; H04L 45/50; H04W 84/22; H04W 4/005; H04W 76/025; H04L 67/12; H04L 67/104; H04L 45/38

(57) ABSTRACT

A method for dynamically establishing an ad-hoc network including a plurality of work machines includes receiving, by a communication module of a first work machine, a data packet, identifying an information type of the data packet, including determining, based on an information type identifier of the data packet, whether the data packet includes one of a first information type or a second information type, processing the data packet based on the information type identification, and forwarding the processed data packet a second work machine. The forwarding includes forwarding the data packet at one of a first rate or a second rate based on the categorization of the data packet into the first type of information or the second type of information.

### TECHNICAL FIELD

The present disclosure relates to ad-hoc communication, and more specifically to a system and method providing ad-hoc peer-to-peer communication between work machines within and across worksites.

### BACKGROUND

Field equipment and worksite machines, such as earthmoving equipment, mining equipment, paving equipment, etc., are increasingly outfitted with programming and monitoring capabilities. For instance, technologies such as position determination, control systems, and autonomous and remote operation may be installed and utilized on worksite machines. For reasons such as improving worksite efficiency and autonomy, worksite machines may be enabled to communicate with one another within or across worksites using a communication network.

Increases in the complexity of communication networks and the amount of information that may be transmitted to and from work machines within and across worksites may decrease the efficiency of communications among the machines. For instance, both the amount of data to be transmitted and the speed at which data transmissions are performed may be limited due to the increased strain on network resources.

U.S. Pat. No. 5,850,592 to Ramanathan implements a system that allows mobile stations to organize themselves into a hierarchical network in which some of the stations operate as message gateways for a cluster of stations. Each station is capable of transmitting messages on either a high power level or a low power level. Although the system disclosed by Ramanathan allows mobile stations to communicate with each other, it does so through cluster gateway stations that are configured to exchange messages between each other at the high power level. Because only cluster gateways are used to pass messages to affiliated non-cluster gateway stations, the system is restricted in its ability to pass information freely between the mobile stations. Further, when two cluster gateways are within a predetermined proximity of each other, the system requires one of them to stand down as a cluster gateway to eliminate redundancy.

The disclosed methods and systems are directed to solve one or more of the problems set forth above and/or other problems in the art.

### SUMMARY OF THE INVENTION

In one aspect, a system is provided for dynamically establishing communications between work machines that may move within a work environment or between work machines located in different work environments. The system includes a communication module disposed on a first work machine positioned in a first location within a first work environment. The communication module provides a data link to at least one of a second work machine with one of the first work environment or a second work environment and a central control station. The communication module is configured to process received data packets for distribution to one or more work machines using modified multiprotocol label switching (MPLS) routing. The communication module may utilize either proactive routing protocols or location-oriented reactive routing protocols to forward data packets according to information types. Upon determining a location of the destination work machine and the information type, the first work machine removes the incoming destination label, inserts new routing information into the data packet by adding a new label and forwards the modified data packet to a second work machine within a time interval based on the information type determination. The communication module may receive the data packet from at least one of an on-board work machine component, a central control station or a third work machine. In some embodiments, the communication module is operably connected to a conversion module that converts a received data packet from a first communication protocol to a second communication protocol.

In one aspect, a method is provided for dynamically providing ad-hoc communication among a plurality of work machines, located within one or more work environments, and at least a portion of which includes at least one of a communication module and a conversion module. The method includes receiving, by a communication module of a first work machine, a data packet and categorizing the data packet into one of at least two information types. The categorizing includes determining, based on an information type identifier of the data packet, whether the data packet includes one of a first information type or a second information type. The method further includes processing the data packet based on the categorization and forwarding the processed data packet to a second work machine. The forwarding includes forwarding the data packet at one of a first rate or a second rate based on the categorization of the data packet into the first type of information or the second type of information.

In one aspect, a computer-readable medium is provided. A processor may be configured to execute instructions stored on a computer-readable medium to perform a method for dynamically establishing an ad-hoc network including a plurality of work machines, one or more of which move within a work environment and each of which includes a communication module. The method is performed by a respective communication module included within a respective one of the work machines and includes receiving, by a communication module of a first work machine, a data packet and categorizing the data packet into one of at least two information types. The categorizing includes determining, based on an information type identifier of the data packet, whether the data packet includes one of a first information type or a second information type. The method further includes processing the data packet based on the categorization and forwarding the processed data packet to a second work machine. The forwarding includes forwarding the data packet at one of a first rate or a second rate based on the categorization of the data packet into the first type of information or the second type of information.

Other features and aspects of this disclosure will be apparent from the following description and the accompanying drawings.

### BRIEF DESCRIPTION OF THE DRAWINGS

The accompanying drawings, which are incorporated in and constitute a part of this specification, illustrate several aspects of the disclosure and together with the description, serve to explain the principles of the disclosure. In the drawings:

FIG. 1 illustrates an ad-hoc work machine environment according to embodiments of the present disclosure;

FIG. 2 illustrates a block diagram of a system that may be configured to perform functions within an ad-hoc network environment according to embodiments of the present disclosure;

FIG. 3 illustrates a flowchart of an exemplary ad-hoc communication process according to embodiments of the present disclosure;

FIG. 4 illustrates a flowchart of an exemplary ad-hoc data packet process flow according to embodiments of the present disclosure;

FIG. 5 illustrates a flowchart of exemplary ad-hoc data packet process flow according to embodiments of the present disclosure; and

FIG. 6 illustrates a modified multi-protocol label switching label according to embodiments of the present disclosure.

### DETAILED DESCRIPTION

Reference will now be made in detail to aspects of the disclosure, examples of which are illustrated in the accompanying drawings. Wherever possible, the same reference numbers will be used throughout the drawings to refer to the same or like parts or elements.

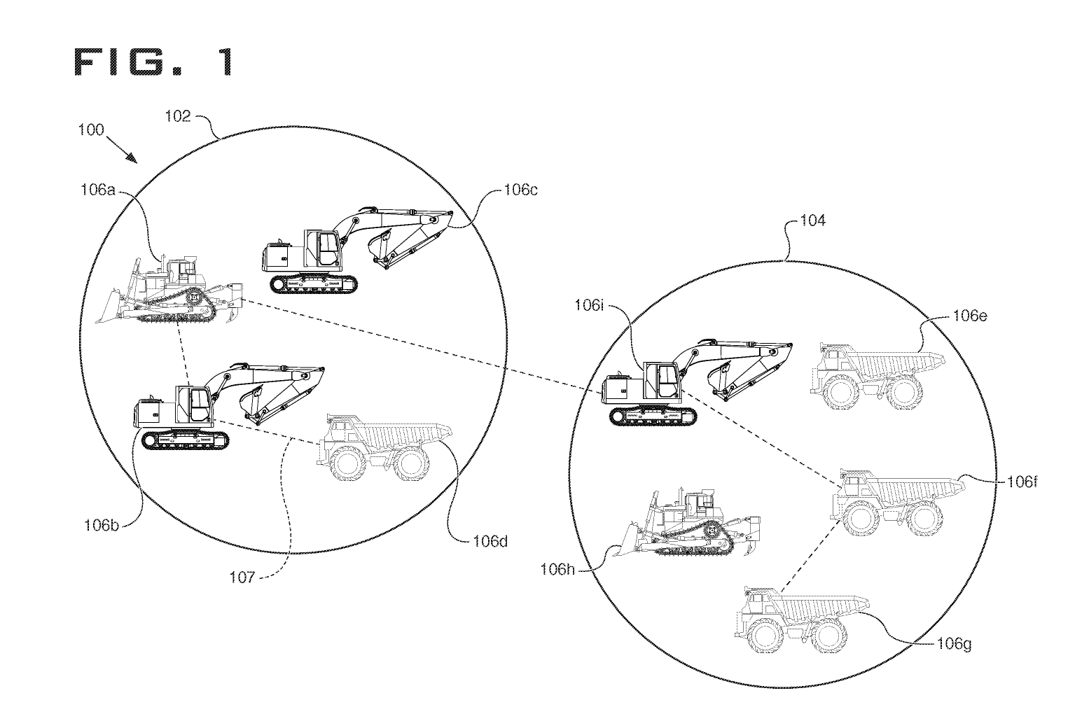

FIG. 1 illustrates an ad-hoc machine-to-machine communication environment 100 (hereinafter also referred to as environment 100) according to embodiments of the present disclosure. The environment 100 may include one or more worksites 102, 104 (e.g., minesites, construction sites, etc.). Embodiments of the disclosure provide a mechanism that allows work machines 106a-106i to travel within or between work environments while dynamically establishing one or more ad-hoc work machine networks including one or more other work machines. An “ad-hoc work machine network,” as the term is used herein, represents a temporarily established network between two or more work machines. Thus, when any two work machines configured according to the disclosure establish communications with each other, an ad-hoc work machine network is established. Additional work machines may gain admission to the network, allowing the network to dynamically change in member size. When a work machine travels out of communication range of any of the work machines within the temporarily established network, the moving machine may be removed from the network. Accordingly, these work machines may dynamically exchange and route message packets to perform a variety of work-related functions, such as sharing work machine operations data, position information, updating work machine software, etc.

As shown in FIG. 1, worksites 102, 104 may include one or more work machines 106a-106i, hereinafter also collectively referred as work machines 106. A work machine, as the term is used herein, refers to a fixed or mobile machine that performs some type of operation associated with a particular industry, such as mining, construction, farming, etc. and operates between or within work environments (e.g., construction site, mine site, power plant, etc.). A non-limiting example of a fixed machine includes an engine system operating in a plant, off-shore environment (e.g., off-shore drilling platform). Non-limiting examples of mobile machines include commercial machines, such as trucks (e.g., mining trucks, a haul trucks, on-highway trucks, an off-highway trucks, an articulated trucks, etc.), cranes, draglines, pipe layers, earth moving vehicles, mining vehicles, backhoes, loaders (e.g., large wheel loaders, track-type loaders, etc.), shovels, material handling equipment, farming equipment, marine vessels, aircraft, and any type of movable machine that operates in a work environment. Such machines deployed on a worksite (e.g., worksites 102, 104) may be manned machines, autonomous machines or semi-autonomous machines.

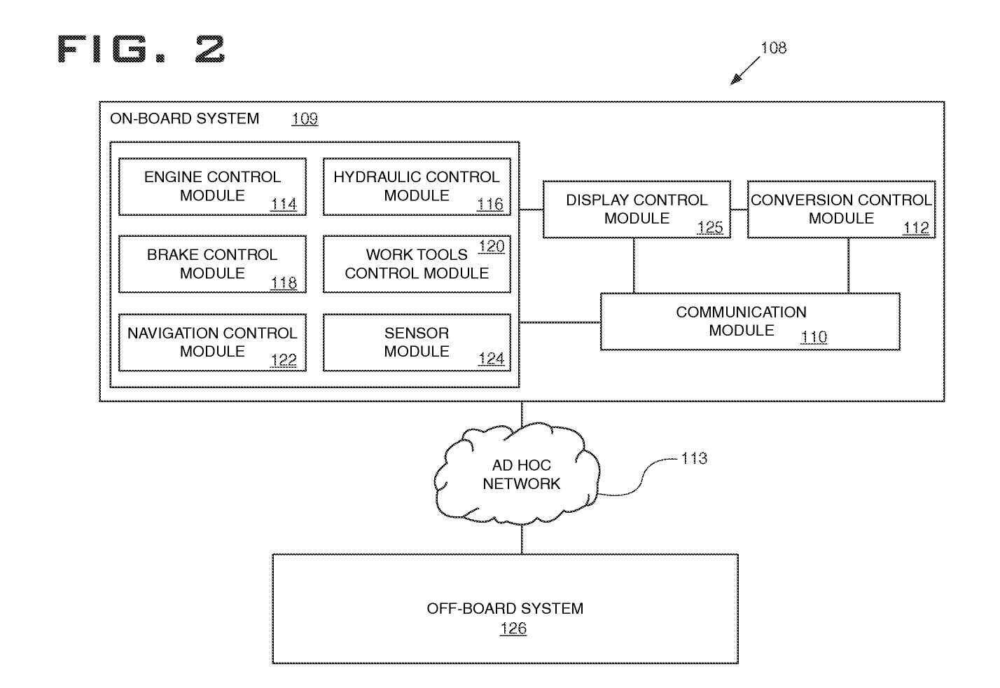

At least a portion of work machines 106 (e.g., work machines 106a, 106b, etc.) may include on-board communications, monitoring systems, and controls. FIG. 2 illustrates a block diagram of a system 108 that may be configured to perform functions within the environment 100 described in FIG. 1. In some embodiments, system 108 includes an on-board system 109 and an off-board system 126. On-board system 109 may include an operator display device and may include any type of power system control module or attachment interface that connects one or more sub-components. Work machine 106 may use the on-board system 109 to facilitate operations of the machine during run time or non-run time conditions (i.e., machine engine running or not running, respectively). For instance, on-board system 109 may include communication module 110, conversion module 112, engine control module 114, hydraulic control module 116, brake control module 118, work tools control module 120, Global Positioning System (GPS)/navigation control module 122, sensor module 124, display module 125 etc.

It is to be appreciated that on-board system 109, as the term is used herein, may represent any type of component operating in work machine 106 that controls or is controlled by other components or sub-components. In one embodiment, the on-board system 109 may be embodied as a remote control station capable of receiving data from one or more control modules (e.g., the engine control module 114) on-board each of the work machines 106. In another embodiment, on-board system 109 may be configured to control an operation of the work machine 106 based on the monitoring of data (e.g., sensor data). One or more modules of on-board system 109 may communicate with other on-board modules to perform various functions related to the operation of the work machine. For example, display module 125 may receive data from an engine control module 114 via a data link (e.g., a J1939 data link), while engine control module 114 supplies estimated torque and fuel information to hydraulic control module 116 via proprietary data links.

Work machine 106 or any control component thereof may also be connected to an off-board system 126 (e.g., centralized server, a remote data management system, off-board computing system, etc.) associated therewith. An off-board system, as the term is used herein, may represent a system that is located remote from a work machine, such as remote from work machine 106. Off-board system 126 may be a workstation, personal digital assistant, laptop, mainframe, etc., and may include one or more computing systems each executing one or more software applications. The off-board system 126 may be implemented on a worksite in a vicinity proximate to one or more worksites (e.g., worksites 102, 104).

Off-board system 126 may include various hardware devices for monitoring of machine data related to the machines operating on the given worksite. For instance, to perform various monitoring and/or control functions, off-board system 126 may include known computing components, such as one or more processors, software, display, and interface devices that operate collectively to perform one or more processes. In certain embodiments, off-board system 126 may include one or more controllers, such as Programmable Logic Controllers (PLCs) that may be used in plants and/or factories. Alternatively, or additionally, the off-board system 126 may include one or more communications devices that facilitate the transmission of data to and from an on-board system (e.g., on-board system 109). Off-board system 126 may also be associated with a user (e.g., customer), multiple users, a business entity (dealer, manufacturer, vendor, etc.), a department of a business entity (e.g., service center, operations support center, logistics center, etc.), and any other type of entity that sends and/or receives information to/from on-board system 109. Further, off-board system 126 may execute off-board software applications that download or upload information to/from on-board system 109 via network.

In some embodiments, on-board system 109 may send data to off-board system 126 using a communication path extending from the work machine to off-board system 126. For instance, the off-board system 126 may connect to an on-board system (e.g., on-board system 109) through Ad-Hoc network 113. The Ad-Hoc network 113 may seamless connect to other existing networks, such as a Local Area Network (LAN), a cellular network, a satellite network, or radio-based communication network. To this end, off-board system 126 may include web browser software that requests and receives data from a server when executed by a processor and displays content to a user operating the system.

Communication module 110 may be communicably coupled to off-board system 126 via a network 113. Network 113 may include a wide area network (WAN), a local area network (LAN), an Ethernet, an Internet, an Intranet, a cellular network, a satellite network, or any other suitable network for transmitting data between communication module 110 and off-board system 126. In various embodiments, network 113 may include a combination of two or more of the aforementioned networks and/or other types of networks known in the art. Network 113 may be implemented as a wired network, a wireless network or a combination thereof. Further, data transmission may take place over network 113 with a network protocol such that the data transmission is in an encrypted format, any other secure format, or in any of a wide variety of known manners.

Off-board system 126 may be deployed over a distributed environment, such as, but not limited to, a cloud facility, internet and virtual private network (VPN). In some embodiments, off-board system 126 may be a distributed data management system that is employed at a location or locations away from or remotely accessible to work machine 106 on a worksite (e.g., worksites 102, 104). In one embodiment, off-board system 126 may be adapted to monitor and report sensor data for work machine 106 operative in a single worksite (e.g., worksite 102). Alternatively, off-board system 126 may be configured to serve as a distributed data warehouse for work machine 106 operative in a given geographical space, such that multiple worksites (e.g., worksites 102 and 104) may be grouped under the same geographical space.

Within and among worksite environments such as the above described, methods for providing a machine-to-machine ad-hoc network may be provided. In accordance with embodiments of the present disclosure, one or more work machines travel during their operations. As the machines travel, they may establish one or more sub-ad-hoc networks with other work machines based on their location and communication capabilities. Collectively, these sub-networks may form an ad-hoc network that allows work machines (as source nodes) to communicate packets through other work machines (as intermediate nodes) to destination work machines (as destination nodes). For example, environment 100 may be an ad-hoc network that includes any number of sub-ad-hoc networks that may be temporarily established based on the locations of work machines.

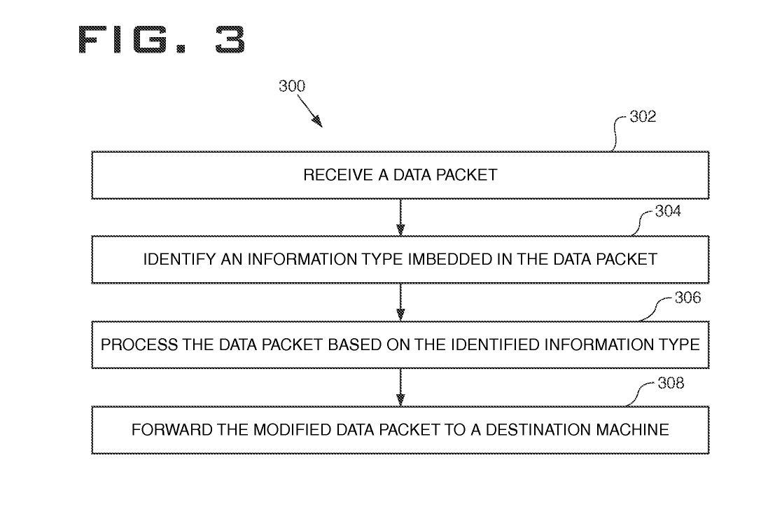

FIG. 3 is a flowchart of a method 300 for providing a machine-to-machine ad-hoc network. It is contemplated that method 300 may be performed in any order suitable for machine-to-machine ad-hoc communications according to embodiments of the disclosure. Method 300 is described for illustration purposes only with respect to the worksite environment and work machine components and processes depicted in FIGS. 1-2 and 4-7. However, it should be apparent that method 300 may be employed with other systems and interfaces. Further, the order of operations of FIG. 3 should not be considered limiting.

Method 300 may begin at operation 302, where an incoming data packet is received at a communication module of a first work machine. For instance, referring to FIGS. 1-2, communication module 110 of work machine 106a may receive the incoming data packet. A data packet may include a request for information from any nodes in the broadcast communications range of a work machine antenna. Further, the data packet may include identifier information associated with work machine 106 and any information collected from the machine (e.g., node identifier and adjacent node identifier information). To receive and process incoming data packets, communication module 110 may operate as an embedded communications server. Accordingly, communication module 110 may be a radio device, a cellular modem, a satellite modem, a Wi-Fi modem, etc. In these embodiments, communication module 110 may include hardware and software that enable it to operate in a communications server-like fashion, receiving information and packet forwarding requests and processing the information and requests.

The data packet may be transmitted from an off-board system (e.g., off-board system 126), from an on-board module (e.g., engine control module) of work machine 106a, or from a component of another work machine (e.g., work machine 106b). Accordingly, when embedded in work machine 106a, communication module 110 may dynamically service requests from any of the on-board elements of on-board system 109 shown in FIG. 2, off-board system 126 and/or other work machines 106b-106i. These requests may also include packets of information provided by a mobile work machine and destined for another mobile work machine.

Communication module 110 may be configured to perform communications applications that determine whether a received packet may be processed locally or should be routed to another work machine for subsequent processing or additional routing. In some embodiments, communication module 110 may execute one or more server applications that allow work machine to communicate with one or more off-board elements, such as another work machine, a Wide Area Satellite Wireless Network (WASWN), a Wireless Local Area Network (WLAN), a Wide-Area Terrestrial Wireless Network (WATWLN), a Wide Area Network (WAN), and one or more external systems. Work machines may also include antennae which interface with communication modules to provide one or more respective off-board data links (e.g., data link 107) to other communication modules consistent with embodiments of the present disclosure.

In some embodiments, prior to the sending or receiving of a data packet, a conversion module (e.g., conversion module 112) may perform one or more protocol translation processes to facilitate communications between different types of data links, whether on-board or off-board. As used herein, the term “translation” refers to converting messages from one data link protocol into comparable messages of another protocol. Conversion module 112 may perform translation for any number of protocols. Packets of messages from multiple and different data links may be discretely or simultaneously translated and sent out on a single data link. Message packets may also be received from a single data link and discretely or simultaneously translated and sent out over multiple and different data links. Non-limiting examples of translations include: (1) Common Data Link (CDL) and J1939 to MODBUS; (2) CDL to ISOI1783; (3) CDL to J1939; (4) Advanced Technology Attachment (ATA) to J1939; and vice versa.

Accordingly, in embodiments where a data packet is received from a component of another work machine, conversion module 112 may translate the data before the data is sent to communication module 110. For instance, in an embodiment where the data packet destination is the first work machine, conversion module 112 may convert or translate the data packet from a first protocol (e.g., the incoming protocol) to a second protocol (e.g., a protocol compatible with the destination module, such as navigation control module 122). In another example, data messages including information such as Parameter Identifier (PID) information may be translated from an off-board data link protocol (e.g., Ethernet) into data values compatible with an on-board data link protocol (e.g., J1939). The PIDs may be associated with one or more operational parameters of work machine 106, such as engine speed, injection rates, component and/or area temperatures, pressures, etc. corresponding to systems, modules, and components located on work machine 106. Further, the parameters may be associated with engine diagnostic and performance parameters associated with engine control module 114. In such instances, a data message may include one or more commands to adjust a PID data value based on a requested action directed to work machine 106. For example, a data message may include a request to increase the engine speed of work machine 106 by adjusting the data values associated with the PID corresponding to engine RPM. In a further example, if the data is sensor data, a controller on-board work machine 106 may send the sensor data of work machine 106 for example, encoded in the field bus protocol (e.g., CAN/CCP), to conversion module 112. Conversion module 112 may then convert this sensor data into a network protocol, for example, the Internet protocol, and further send the sensor data to the communication module 110 for transmission over the network 113 to the off-board system 126. During translation, conversion module 112 may also impose a tag onto the data sent to communication module 110 indicating the subsystem, protocol and port information associated with the data.

Once the converted or raw data has been received at the communication module, method 300, at operation 304, may identify an information type imbedded in the data packet. While several types of information data may be transmitted from one machine to another across the ad-hoc network, the information may be categorized or sorted into at least two primary categories. A first information type or first category of information may be classified as machine and machine subsystem (e.g., engine, hydraulic system, etc.) sensor and control information. First category information may be transmitted to coordinate the operation of a group of machines. In some cases, there are direct physical contacts between machines when they cooperate with each other to perform certain tasks. For example, an off-highway truck may receive a load from an excavator, a first track type tractor may push a second track type tractor to perform an earth moving task, or two machines may communicate hydraulic and engine control information, such as engine governor gains. First category information may include one or more characteristics relating to time and/or distance. For example, first category information may be time sensitive. Specifically, a first category information packet may include information that expires after a relatively short period of time, and therefore should be communicated to the destination machine within a prescribed time period (e.g., to provide machine cooperation within a set time period). First category information may also be location sensitive (e.g., a machine sending or receiving first category information may be in relatively close proximity to a source or destination machine).

A second information type or category of information may include log, service, maintenance and/or other machine operating information utilized to facilitate machine and fleet maintenance. With respect to the second type of information, the data transfer may be over a longer distance than first category information (e.g., from a server on one worksite to another worksite 25 miles away). For instance, machine log data may be collected by a server in a remote location (e.g., at an original equipment manufacturer (OEM) research or data center located several miles from a mine site). To facilitate data transfer from an OEM to a work machine, in some instances, the ad-hoc network may function as a public network, where each machine and OEM may have access to the network and communicate with other machines in the network. In other instances, as will be described in further detail below, a VPN based on the above described machine-to-machine ad-hoc network may be established to allow machines from different OEMs to establish a virtual point-to-point connection with their respective back offices while sharing the ad-hoc network on a worksite.

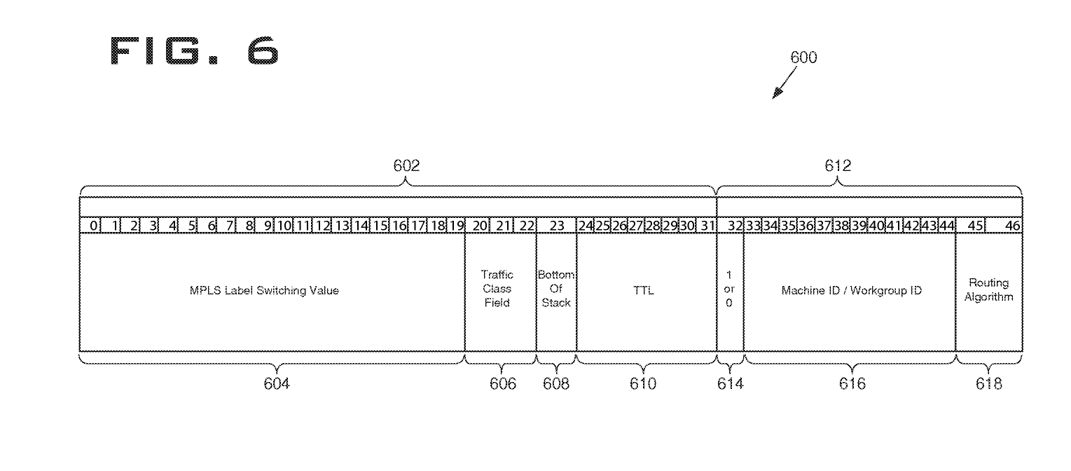

Communication module 110 may use an incoming data packet label to identify the information type. The communication module on each machine may assign labels to data packets received from an external source (e.g., a server) or from conversion module 112. In some embodiments, the label is a modified MPLS routing label. A MPLS label may be defined as a short fixed length physically contiguous identifier which is used to identify a group of packets that will be forwarded through a MPLS network along the same label switched path (LSP) and with the same forwarding treatment. The label may be a packet header component used to index the forwarding decision made by communication module 110 (acting as a label switching router (LSR)). FIG. 6 illustrates a modified MPLS label 600. As can be seen in FIG. 6, bits 0-31 602 represent a standard MPLS label, where bits 0-19 604 represent a standard MPLS label switching value, bits 20-22 606 represent a traffic class field, bit 23 608 represents a bottom of the label stack, and bits 24-31 610 represent a time-to-live (TTL) portion of the MPLS label. Bits 32-46 612 may generally be designated for machine-to-machine ad-hoc packet routing. Bit 32 614 may indicate a type of routing protocol: proactive, for first category information or reactive for second category information. Bits 33-44 616 may indicate a 12-bit machine ID and a workgroup ID. Bits 45-46 618 may indicate a routing algorithm for the machine-to-machine ad-hoc packet routing.

Upon receipt of a data packet, at least a portion of the modified MPLS label (e.g., Bit 32) may be used by communication module 110 to determine whether the packet includes first category information or second category information. The category allows the establishment of an appropriate LSP through the worksite or across worksites. Because the modified MPLS label value will determine the appropriate label switch routing, the category for a packet may be determined prior to the data packet entering an ingress LSR (e.g., communication module 110).

Continuing the process described in method 300, at operation 306, the data packet may be processed based on the identified information type. In some embodiments, a modified MPLS routing method may then be utilized to implement routing tasks along a LSP. The forwarding of packets through a LSP may be opaque to higher network layers, such as IP network. In some embodiments, a LSP may also be referred to as a MPLS tunnel. As a work machine travels, communication module 110 may be configured to execute a communications application that processes received data packets in real time, periodically or at other points in time, using the modified MPLS routing method. When a packet is received, communication module 110 may act as an in ingress LSR. As an ingress LSR, communication module 110 may be configured to add, change and/or remove a routing label of a data packet. Specifically, communication module 110 may be configured to perform label switch routing on a received data packet.

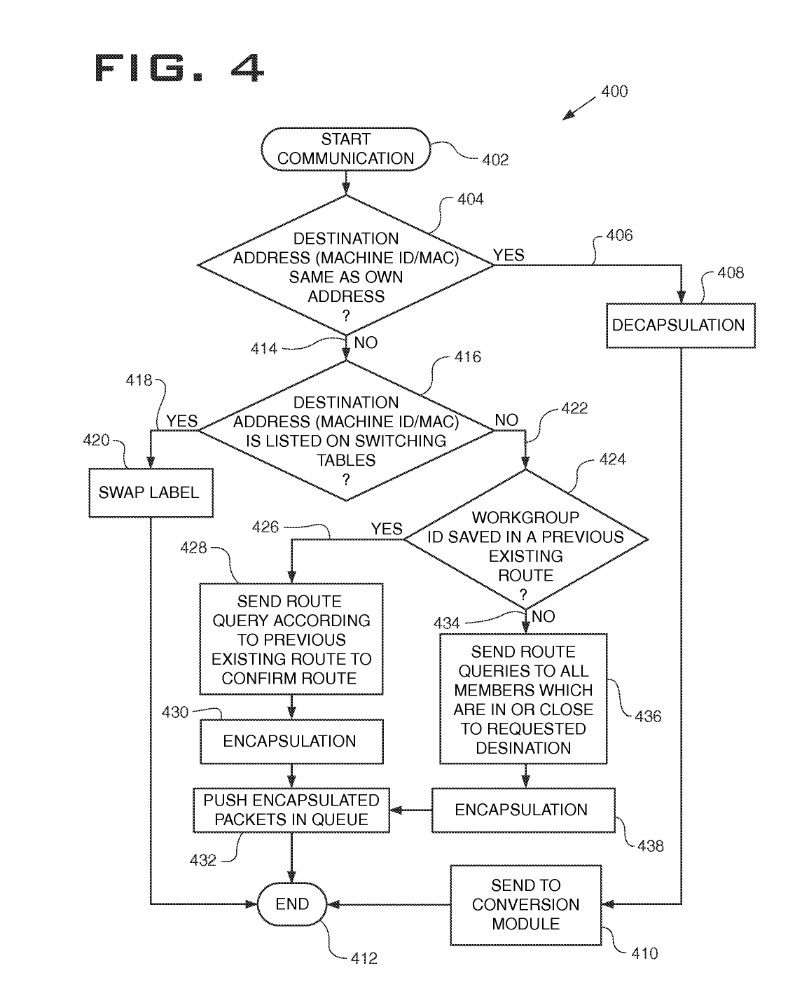

During initial packet processing, a determination may be made whether to proactively or reactively route the information in the data packet based on the identified information type. Proactive routing may be used, for instance, within a worksite in scenarios when information is time sensitive (e.g., during a communication between an off-highway truck and a loader during a material transfer). To further illustrate the transfer of data within a worksite or group (e.g., proactive routing), FIG. 4 shows a flowchart of an exemplary proactive multi-layer communications process 400 that may be performed by a communication module of any work machine 106. For exemplary purposes, FIG. 4 will be described with reference to FIGS. 1, 2 and 6; however, the following description may apply to any work machines and communication modules sending packets to any other nodes within or across worksites.

Upon receiving a data packet, as described in operation 302, and identifying an information type, as described in operation 304, a communication module (e.g., communication module 110) may initiate a proactive data packet processing flow 402 for first category information. That is, communication module 110, acting as a MPLS-enabled LSR, may receive a modified MPLS labeled packet, read the incoming label and compare the label value with a predefined forwarding table to determine a next route for the packet. If communication module 110 is not the egress edge LSR for the data packet (e.g., the last node in the route prior to the destination node), then communication module 110 may remove the incoming label, and attach an appropriate outgoing label to the packet.

Upon receipt of a data packet, the modified MPLS label included in the packet header may be used by communication module 110 as an index to determine a next hop on the LSP. For instance, upon receiving or generating a data packet, communication module 110 may first determine whether the destination machine address (e.g., MAC/ID number) is the address of the machine associated with communication module 110 (Step 404). Since communication module 110 may be implemented by stand-alone machine gateway equipment, the media access control address (MAC) of the machine might not be bundled with machine ID. It is preferable for communication module 110 to use unique machine ID specified in the modified MPLS label to determine machine address. If the destination machine address is associated with the source communication module's machine (Step 406, YES), a decapsulation process may be performed on the received message (Step 408) to retrieve the packet payload. Following the decapsulation process, the packet may be sent to a conversion module (Step 410) of the work machine for further processing, whereby the communication sequence ends (Step 412).

If the destination machine address is not associated with communication module's machine (Step 414, NO), the communication module may determine whether the destination address is listed on a switching table accessible by the communication module (Step 416). For instance, if communication module 110 determines that the data packet is to be forwarded to another work machine within a workgroup, communication module 110 may utilize a proactive MPLS routing protocol to forward data packets within a workgroup. The packet may then be forwarded along a LSP to a next communication module (acting as a next LSR). In order to effectively forward type I information, each node (e.g., work machine) in the ad-hoc network may proactively maintain, using a switching table, routes to destinations within a local neighborhood. As used herein, a local neighborhood may be defined as a collection of nodes whose minimum distance in hops from the node in question is no greater than a parameter (zone radius or cluster radius). Each node may be aware of all node neighbors by broadcasting routing updates periodically. Since the broadcasting is performed within a local zone rather than across the whole network, network capacity may be saved to transfer other information. However, each node may define its own workgroup or neighbors, workgroup members may change from time to time (e.g., as a work machine travels from one worksite to another). Thus, communication module 110 may also be configured to access a label lookup table including information for members within a defined group (e.g., a worksite) as the join or leave the workgroup. Each packet to be forwarded using the proactive routing process may then be assigned a label number and the switching may be performed after examination of the label assigned to the packet. If the destination the destination address is listed on a switching table (Step 418, YES), communication module 110 may perform a label switch (e.g., swap the incoming message label for an outgoing message label) to route the message to the destination address (Step 420). In some embodiments, the switching of data occurs at layer 2.5, rather than layer 3 (e.g., the IP layer). The switching is fast when a short lookup table is used. Although the communication module 110 may not have address tables that cover the ad hoc network in its entirety, most first category information may be effectively handled or forwarded due to to the time and distance characteristics of first category information.

On the other hand, if the destination address is not listed on the switching table (Step 422, NO), communication module 110 may locate a route before forwarding, and hence reactive routing may be utilized for first category information instead of proactive routing. Communication module 110 may first determine whether a workgroup ID is saved in a previous existing route (Step 424). Although the processing of most first category information will be done using proactive routing, the method may encounter a situation where a first category information address is not available in a lookup table. In such instances, switching from proactive routing to reactive routing is also contemplated. This switching is described in Steps 424-426. As can be seen, the workgroup ID may be shared by work machines in the same worksite or workgroup. If the workgroup ID is saved in a previous existing route (Step 426, YES), communication module 110 may send a route query or queries to the work machines that have the same workgroup ID according to the previous existing route to confirm the route (Step 428). Communication module 110 may then perform an encapsulation operation on the message (Step 430) and push the encapsulated packet or packets into a routing queue (Step 432) waiting for the confirmed response. Upon pushing the packet into the queue, the communication sequence may end (Step 412). On the other hand, if the workgroup ID is not saved in a previous existing route (Step 434, NO), communication module 110 may send one or more route queries to one or more members which are in or are close to requested destination (Step 436). Communication module 110 may then perform an encapsulation operation on the message (Step 438) and push the encapsulated packet or packets into a routing queue (Step 430) waiting for the confirmed response. Upon pushing the packet into the queue, the communication sequence may end (Step 412).

If a data packet includes second category information, communication module 110 may utilize location-oriented reactive routing protocols to transfer data outside the workgroup. As with proactive routing, a modified MPLS routing method may be utilized to implement location-oriented reactive routing tasks. For instance, if a communication module identifies the data packet as including second category information, a reactive routing process may be performed. Reactive routing may be used, for instance, across worksites in scenarios when information is not as time sensitive (e.g., alerting a work machine that an oil change is due or forwarding machine diagnostics to an off-board system). When most second category information relies on reactive routing, a zone radius or cluster radius of each node may decrease, and hence the lookup tables maintained by each node for proactive routing may also be reduced. The saved network capacity may provide the execution of first category information forwarding at a higher priority.

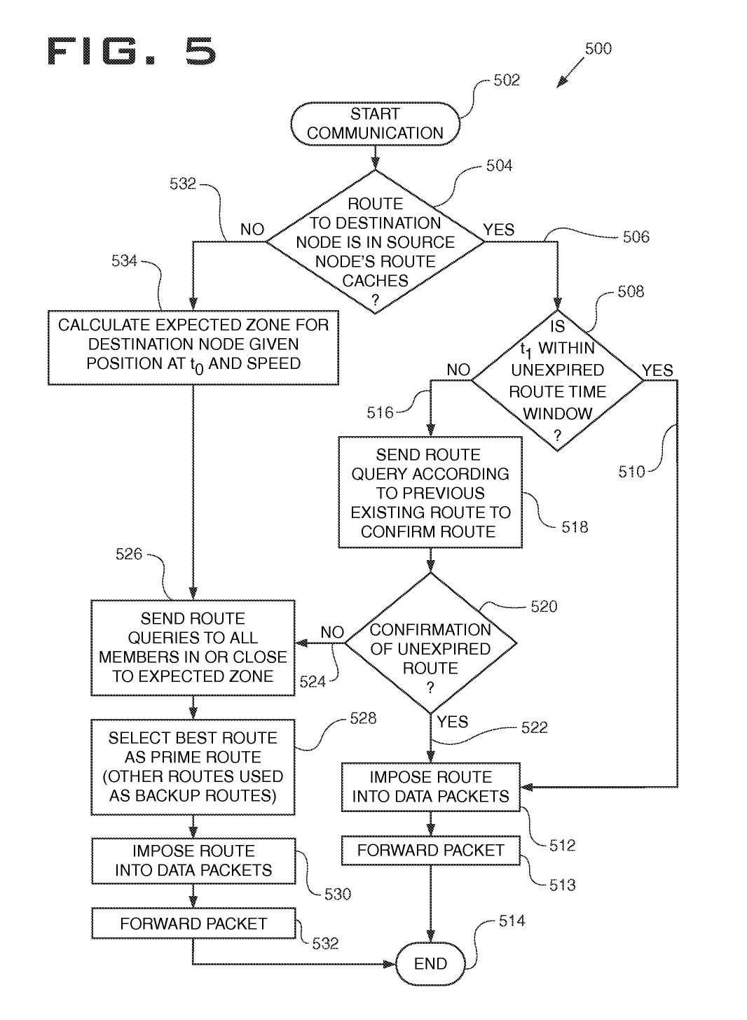

To better describe the transfer of data to a machine outside of a worksite or group, FIG. 5 shows a flowchart of an exemplary reactive multi-layer communications process 500 that may be performed by a communication module of any work machine 106. For exemplary purposes, FIG. 5 will be described with reference to FIGS. 1, 2 and 6; however, the following description may apply to any work machine and communication module sending packets to other nodes within or across worksites. Communication module 110 may first initiate communication 502 (e.g., upon receiving or generating a message packet). Communication module 110 may determine whether the route to the destination node is in a route cache of the source node (e.g., a first work machine) (Step 504). If the route exists in a first work machine's route cache (Step 506, YES), communication module 110 may determine whether the last used or known time of the route t₁ is within a determined unexpired route time window (Step 508). If time t₁ is within a determined unexpired route time window (Step 510, YES), the communication module may impose the route into the data packets (Step 512) without sending a route query. Communication module 110 may forward the data packets accordingly (Step 513), and the communication sequence ends (Step 514). If time t₁ is not within a determined unexpired route time window (Step 516, NO), communication module 110 may send a route query according to a previous existing route to confirm the route (Step 518). The communication module may then confirm whether the route is unexpired (Step 520) and if so (Step 522, YES), the communication module may impose the route into the data packets (Step 512) and forward the data packets accordingly (Step 513), whereby the communication sequence ends (Step 514).

If the route is expired (Step 524, NO), the communication module may send route queries to all members in or close to the expected zone (Step 526). Since the broadcasting is location-oriented, as will be illustrated later, in most cases, query packets may be sent toward certain directions only to save a network capacity. Once generated, work machine 106 may broadcast the query using any data links available to another machine in its current location. In some embodiments, a source node (e.g., work machine 106a) may broadcast the query over a data link (e.g., a radio data link). A source node may receive many route reply packets in the reactive routing mode. Communication module 110 may then determine the best suitable route (e.g., the first received route) as a primary route for the communication (Step 528) according to one or more routing algorithms. At least one additional route may also be designated as a back-up route. Upon selecting a primary route, communication module 110 may impose the route into the data packets (Step 530) and forward data packets accordingly (Step 532), whereby the communication sequence ends (Step 514). Returning to the beginning of the communication sequence, if the route to the destination node is not in one of the source node's route caches (Step 532, NO), the source node may broadcast queries to all members close to an intended destination. For instance, communication module 110 may calculate an expected zone for a destination node according to the initial conditions that consist of last known machine position at time t₀ and a machine speed at time t₀ as well (Step 534). During the calculation, machine speed is assumed to be either constant or vary according to certain functions that might include GPS or terrain information as function input as well. For example, assuming that a source node knows a location of a destination node location at t₀ and the speed of the destination node, a source node may predict a possible region encompassing the destination node at a later time tᵢ. Upon calculating the expected zone, the communication module may send route queries to all members in or close to the expected zone (Step 526). The source node may receive many route reply packets in reactive routing mode. Communication module 110 may then determine the best suitable route (e.g., the first received route) as a primary route for the communication (Step 528) according to one or more routing algorithms. At least one additional route may be designated as a back-up route. The backup route information may be copied into a lower layer of the label stack. One of the advantages for the multi routes replies is that network resilience may be improved. Upon selecting a primary route, the communication module may impose the route into the data packets (Step 512) and forward data packets accordingly (Step 513), whereby the communication sequence ends (Step 514).

If a first work machine (e.g., a source node) does not know a previous location of the destination work machine, then the first work machine lacks the initial conditions to estimate the expected zone, and the entire region of the ad-hoc network is assumed to be the expected region. In this case, a first work machine may send route queries to all members listed in a defined workgroup. A route reply may be generated when the route request reaches either the destination node or a node that has an unexpired route to the destination. If the responding node is the destination node, communication module 110 may place the route record (the sequence of hops during search process) into a route reply packet. If the responding node is an intermediate node, communication module 110 may append the cached route to the route record. The route reply packet may reverse the route in the route record to reach the first work machine. When the source node receives the route record, the route record may be imposed onto data packets which are in the queue. The route record may then be copied into a top layer of the MPLS label stack, and then the communication module 110 may send out the data packets according to the label switched route.

At operation 308, the first communication module may forward the data packets to the next communication module or modules according to either the proactive routing or reactive routing methods described above.

In some embodiments, the disclosed environment 100 may be linked to a different type of network such as a Local Area Network (LAN) through an ingress MPLS switcher of LAN. Since the ad-hoc machine-to-machine communication utilizes a modified MPLS label, the LAN may seamlessly connect to the ad-hoc machine-to-machine communication environment 100 through standard MPLS technologies. An off-board system 126 that is physically located close to a LAN might receive data packets with modified MPLS label from a communication module located in any work machine 106. The off-board system 126 might remove bits 32-46 612 from modified MPLS label and the left portion becomes a standard MPLS label. The off-board system 126 works as a gateway and forwards data packets with standard MPLS label to a Label Edge Router (LER) of a LAN. When data packets are received by a MPLS router, the topmost MPLS label is examined. According to the contents of the label, data packets may be forwarded, encapsulated or decapsulated. In some embodiments, a MPLS route may include one or more intermediate LSRs that forward the data packet until the data packet reaches an egress LSR.

One of benefits for seamless connection to a MPLS fixed network such as a MPLS LAN is the capability to extend a local or global VPN to the ad-hoc machine-to-machine network. When many OEMs' machines operate in a work site, machines from different OEMs may establish a public ad-hoc machine-to-machine network while maintaining a virtual point-to-point connection with their own manufactures' data servers.

In some embodiments, communication module 110 may communicate with specific servers located in worksites via a local VPN. As discussed above, an on-board network may include many different on-board systems connected to various types of communication links. These links may be proprietary and non-proprietary, such as manufacturer-based data links and communication paths based on known industry standards (such as J1939, RS-232, RS-422, RS-485, CAN, etc.). Machine OEMs typically validate that on-board systems may communicate with other on-board systems in the same machine to perform various functions before OEMs deliver machines to clients. For example, an engine on first work machine may provide engine speed information or engine oil temperature information to the transmission control module on the same machine. Many work machines from different OEMs may dynamically establish an ad-hoc machine-to-machine network. Data packets may then hop between different OEMs' machines before finally reaching an off-board server located in a worksite.

To communicate data packets via a VPN, method 300 may provide modified MPLS supported VPN by creating one or more virtual circuits or tunnels across an ad-hoc machine-to-machine network. Accordingly, modified MPLS may improve VPN scalability and network management. Modified MPLS supported VPN may also allow privacy level setting (e.g., method 300 may assign the same level of privacy as a frame relay or ATM-networked circuit). To provide modified MPLS VPN, an incoming data packet must include VPN membership information. Upon verifying the VPN membership data, the packet may be received by communication module 110 for processing. Communication module may attach a modified MPLS label to a received data packet that corresponds to a specific network, based on VPN membership and a packet destination. With the extended VPN capability supplied by a modified MPLS label in an ad-hoc machine-to-machine network, a server located in a local worksite may exchange business sensitive data packets with a communication module located in any work machine from the same OME via VPN

In some embodiments, method 300 may also employ one or more additional encryption methods (e.g., IPsec) for packet encryption. In further embodiments, VPN may also be globally configured. For instance, an on-board communication module 110 may send performance data packets to a database server located in an OEM's R&D campus that is far away from the worksite. A first communication module (e.g., communication module 110), acting as a corresponding LSR in the ad-hoc machine-to machine network may forward one or more data packets to a second communication module. When the data packets finally reach a Label Edge Router (LER) in the LAN, standard MPLS switching is enabled by popping bits 32-46 612 off the modified MPLS label.

When the data packets reach an egress LSR, the egress LSR may then remove the modified MPLS label from the data packets, and examine the upper layer (e.g., Layer 3 or IP layer), which is encapsulated by a modified MPLS label, and forward the resulting IP packets using traditional IP forwarding rules. Traditional layer 3 VPN or Virtual Private Routed Network (VPRN) may be used to route business sensitive data packets between a server located in a corporate R&D center and another server located in work sites. With the extended VPN capability supplied by a modified MPLS label in an ad-hoc machine-to-machine network, a server located in a corporate R&D center may exchange business sensitive data packets with a communication module located in any work machine from the same OME via VPN.

It should be appreciated that any of the above described components may embody a single microprocessor or multiple microprocessors known in art. Numerous commercially available microprocessors may be configured to perform the functions of the on-board system 109, the off-board system 126 and/or any related and the servers or computing systems. It should also be appreciated that on and off-board modules or systems may readily embody a general microprocessor. A person of ordinary skill in the art will appreciate that the on and off-board modules or systems may additionally include other components and may also perform other functionality not described herein. It should be understood that the embodiments, configurations and connections explained herein are merely on an exemplary basis and may not limit the scope and spirit of the disclosure.

### INDUSTRIAL APPLICABILITY

The present disclosure provides an ad-hoc machine-to-machine communication environment 100 for work machines within and across worksites. The environment 100 connects work machines operating within a worksite (e.g., worksites 102, 104) or across worksites by facilitating communication of data from one machine to another via an on-board communication module (e.g., communication module 110).

Methods and systems consistent with embodiments of the present disclosure allow work machines to dynamically establish one or more ad-hoc work machine networks as the machines travel within or between work environments. Such systems and methods facilitate the transmission and routing of message packets between moving work machines without the need for any fixed access point facilities. In some embodiments, a moving working machine may act as a temporary access point that delivers message packets to another work machine in the ad-hoc communication environment.

The embodiments of the present disclosure may be applied to various applications to allow work machines to share information without the constraint of fixed network boundaries. For example, work machines in a mining work environment may receive and share status information regarding the overall performance of the environment and the performance of individual machines within the environment. Also, a central site office may issue a software update message to update the software of an on-board system of particular types of work machines operating within a work environment. In such an example, the central office may send the update information in a packet that is received by one or more work machines that are in communication range of the office. The work machines may process the information (i.e., update its software if the machine matches the type of machine identified in the message) and/or forward the packet to a destination work machine included in the ad-hoc network containing the machine that initially received the update message. Other types of messages, data, and information may be relayed between work machines as well.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for dynamically establishing an ad-hoc network including a plurality of work machines comprising:
receiving, by a communication module of a first work machine, a data packet;
identifying an information type of the data packet, wherein the identifying includes determining, based on an information type identifier of the data packet, whether the data packet includes one of a first information type or a second information type; and
processing the data packet based on the information type identification;
forwarding the processed data packet to a second work machine, wherein the forwarding includes forwarding the data packet at one of a first rate or a second rate based on the categorization of the data packet into the first type of information or the second type of information.

2. The method of claim 1, further including performing, using a conversion module, a protocol translation process on the data packet.

3. The method of claim 1, wherein the first information type includes information that expires within a first period of time and the second information type includes information that expires within a second period of time, the second period of time being longer than the first period of time.

4. The method of claim 1, wherein the first information type includes at least one of machine and machine subsystem sensor and control information and the second information type includes at least one of log, service, maintenance and operation information.

5. The method of claim 1, wherein the data packet includes a first modified multiprotocol label switching (MPLS) routing label.

6. The method of claim 5, wherein at least a portion of the modified MPLS routing label identifies the information type of the data packet.

7. The method of claim 6, further including, if the information type of the data packet is a first information type, routing the data packet to the second work machine using proactive routing.

8. The method of claim 7, further comprising:
maintaining a switching table including one or more routes to the second work machine;
replacing the first modified MPLS label of the data packet with a second modified MPLS label; and
pushing the data packet to a third work machine in the ad-hoc network, by removing the second modified MPLS label of the data packet and forward the data packet to the second work machine.

9. The method of claim 6, further comprising, if the information type of the data packet is a second information type, routing the data packet using location oriented reactive routing.

10. The method of claim 9, further comprising:
sending a route query to one or more work machines based on a route cache stored on the first work machine;
determining whether one or more available routes to the second work machine are expired; and
if an unexpired route exists, imposing the route into the data packet.

11. The method of claim 1, further comprising:
using a virtual private network (VPN) tunnel to forward the data packet to the second work machine or to an original equipment manufacturer (OEM) server located on the worksite or at a location external to the worksite.

12. A system for dynamically establishing communications between work machines, one or more of which may move within a work environment, the system comprising:
a first work machine positioned in a first location within the work environment;
a communication module included in the first work machine, wherein the communication module is configured to:
receive a data packet;
categorize the data packet into one of at least two information types, wherein the categorizing includes determining, based on an information type identifier of the data packet, whether the data packet includes one of a first information type or a second information type;
process the data packet based on the categorization; and
forward the processed data packet to a second work machine, wherein the forwarding includes forwarding the data packet at one of a first rate or a second rate based on the categorization of the data packet into the first type of information or the second type of information.

13. The system of claim 12, further including a conversion module configured to perform a protocol translation process on the data packet prior to the first communication module.

14. The system of claim 12, wherein the first information type includes information that expires within a first period of time and the second information type includes information that expires within a second period of time, the second period of time being longer than the first period of time.

15. The system of claim 12, wherein the first information type includes at least one of machine and machine subsystem sensor and control information and the second information type includes at least one of log, service, maintenance and operation information.

16. The system of claim 12, wherein the data packet includes a first modified multiprotocol label switching (MPLS) routing label.

17. The system of claim 16, wherein at least a portion of the modified MPLS routing label identifies the information type of the data packet.

18. The system of claim 17, further including, if the information type of the data packet is a first information type, routing the data packet to the second work machine using proactive MPLS routing.

19. The system of claim 17, wherein, if a first information type address is not available in a lookup table, switching from proactive routing to reactive routing to appropriately route the data packet according to a reactive routing process.

20. A computer-readable medium including instructions for performing, when executed by a processor, a method for dynamically establishing an ad-hoc network including a plurality of work machines, one or more of which move within a work environment and each of which includes a communication module, the method performed by a respective communication module included within a respective one of the work machines comprising:
receiving, by a communication module of a first work machine, a data packet;
categorizing the data packet into one of at least two information types, wherein the categorizing includes determining, based on an information type identifier of the data packet, whether the data packet includes one of a first information type or a second information type;
processing the data packet based on the categorization; and
forwarding, using a virtual private network (VPN) tunnel, the processed data packet to a second work machine, wherein the forwarding includes forwarding the data packet at one of a first rate or a second rate based on the categorization of the data packet into the first type of information or the second type of information.
